(19) United States
(12) Patent Application Publication
(10) Pub. No.: US 2008/0090607 A1
(43) Pub. Date: Apr. 17, 2008

(54) MOBILE COMMUNICATION TERMINAL AND METHOD THEREOF

(76) Inventors: Christian KRAFT, Frederiksberg C (DK); Peter Dam Nielsen, Lyngby (DK)

Correspondence Address: PERMAN & GREEN, 425 POST ROAD, FAIRFIELD, CT, 06824, US

(21) Appl. No.: 11/548,426

(22) Filed: Oct. 11, 2006

(51) Int. Cl. H04N 1/40

(52) U.S. Cl. 455/556.1

(57) ABSTRACT

A method for amending data for an apparatus in a camera mode including a keypad, a display and a camera, as well as an apparatus and a computer-readable medium thereof. First, a camera mode is entered. Next, the keypad configuration is switched to a camera mode keypad configuration. Next, image data is received. Thereafter, upon an actuation of a first key of said keypad, a data amending function is executed. Finally, by using the data amending function, the data is amended.

### FIELD

The disclosed embodiments generally relate to a method for amending data for an apparatus comprising a keypad, a display and a camera, as well as an apparatus and a computer-readable medium thereof.

### BACKGROUND

Many mobile communication terminals of today includes a digital camera. A great advantage of having a digital camera included is that, instead of two separate units, only one single unit is needed for users asking for a mobile terminal as well as a digital camera.

By including a digital camera in a mobile communication terminal, some of the hardware of the mobile terminal may be used by the digital camera as well. For instance, the display may be used by the digital camera in order to show current image data or stored favourite photos.

Most often, it is possible to switch from mobile terminal functionality to digital camera functionality in one simple operation, e.g. by removing the lens cover.

Although a number of hardware synergies may be achieved by including a digital camera on the same platform as a mobile terminal, the digital camera and the mobile terminal are in many cases treated as two separate devices sharing one platform. Therefore, there is a need to more closely connect the digital camera to the mobile communication terminal in order to increase the customer satisfaction.

### SUMMARY

In view of the above, disclosed embodiments aim to solve or at least reduce the problems discussed above. In particular, an advantage of the disclosed embodiments is to more closely connect a camera comprised within an apparatus to the other functions and the hardware of the of the apparatus.

In a first aspect, the disclosed embodimentsare directed to a method for amending data for an apparatus in a camera mode, said apparatus comprising a keypad, a display and a camera, said method comprising entering a camera mode, switching keypad configuration to a camera mode keypad configuration, receiving image data, showing said image data on said display, executing a data amending function upon an actuation of a first key of said keypad, and amending said data using said data amending function.

An advantage of switching keypad configuration is that a number of camera related functions may be easily reached in a camera mode via the keypad.

Another advantage is that less key input actuations is needed in order to amend the data. The data amending function may be an image manipulating function configured to manipulate image data captured by said apparatus.

The image manipulating function may comprise an image filter function.

The image filter function may be a BW (black and white) image filter function, i.e. a function which transforms color image data to greyscale image data, or a Sepia image filter function, i.e. a function which transforms color image data to Sepia image data, or any other image filter function.

The image manipulating function may comprise an image cropping function.

An advantage of this is that the part of the image data which is of interest may be stored, and the rest of the image data may be removed. In this way the image data of interest may be stored, which, in turn, implies a more memory efficient apparatus.

The image manipulating function may comprise a text adding function.

An advantage of this is that the image data may be complemented with a describing text.

The apparatus may further comprise a cursor control mechanism, wherein said method may further comprise receiving cursor control output data, transforming said cursor control output data to coordinate data, and transmitting said coordinate data to said image manipulating function.

The coordinate data may be utilised in order to determine the location in the image data for the text generated by the text adding function described above. There are two ways for adding a text, either by first adding the text using character related keys and then determining the location of the text using the coordinate data, or by first determining the location of the text using the coordinate data and then adding the text. If the second alternative is chosen, i.e. first determining the location of the text, a text box may be used in order to see where the coming text will be placed. In this way, either the actuation of a cursor control mechanism or the actuation of a character related key may start the text adding function, or any other image manipulating function using coordinate data as well as functions associated to character related keys.

An advantage of this is that additional data may be given to the image manipulating function. For example, the coordinate data may determine where to place the text generated by the text adding function.

The first key may be a character related key of said keypad.

An advantage of using a character related key as the first key is that the image manipulating function may be reached by only pressing one button, which implies a quicker user interface in camera mode.

The method may further comprise executing an image sending function upon an actuation of a second key of said keypad, and sending said image data using said image sending function.

Such an image sending function may be a function for sending image data to another apparatus using MMS, e-mail etc. Alternatively, such an image sending function may be a function configured to send image data to an external storing media, such as a hard drive or a server. Still an alternative is to automatically send the image data to a web server and to publish the image data on the Internet.

An advantage of this is that the image data may fast and easily be sent to a recipient or a storing place.

The second key may be a character related key of the keypad.

The method may further comprise executing a meta information handling function upon an actuation of a third key of said keypad, and handling meta information associated to said image data using said meta information handling function.

Such a meta information handling function may be a function making it possible to add, or edit, a title of the image data, a subject relating to the image data, an author of the image data, a company name, a category, comments, a key word, etc.

By having a third key associated to a meta information handling function, meta information associated to the image data may fast and easily be added or edited. An advantage of having meta information associated to image data is that it is easier to search among a number of stored image files.

The meta information handling function may comprise a file name handling function.

The third key may be a character related key.

The method may further comprise executing an image displaying function upon an actuation of a fourth key of said keypad, and displaying said image data using said image displaying function.

An advantage of this is that the displaying of image data may fast and easily be changed according to the preferences of the user.

The image displaying function may comprise a zoom in function.

The image displaying function may comprise a zoom out function.

An advantage of having zoom in or zoom out functions associated to the fourth key is that the image data may be easily viewed with different enlargement.

The image displaying function may comprise a full screen function.

An advantage of this is that it is easy to view the image data on the entire display.

The apparatus may further comprise a cursor control mechanism, wherein said method may further comprise receiving cursor control output data, transforming said cursor control output data to coordinate data, and transmitting said coordinate data to said image displaying function.

An advantage of transmitting coordinate data to the image displaying function is, for example, that it is possible to determine which part of the image data that is to be zoomed in.

The fourth key may be a character related key.

The data amending function according to the first aspect may be a text associating function configured to associate a text to said image data, wherein said amending comprises receiving a text upon actuation of at least one character related key of said keypad, and associating said text to said image data.

An advantage of this is that it is easy to name, or rename, an image file comprising the image data, which is stored or is to be stored.

Another advantage is that it is easy to add a text to the image data, such as a describing text. This implies that the user of the apparatus is able to easily edit the image data, which, in turn, enhance the user experience.

The data amending function may further comprise receiving cursor control output data from a cursor control mechanism, transforming said cursor control output data to coordinate data, and locating said associated text in a position in said image data corresponding to said coordinate data.

An advantage of this is that the location of the text may be determined by the user by using the cursor control mechanism.

Alternatively, the text may be shown in a text box. In this case, although no text is input, the location of the text box may be changed using the cursor control mechanism of the apparatus.

The associating may comprise storing said image data as an image file, and naming said image file in accordance to said associated text.

An advantage of this is that the name of the image file may easily be set. By making it is easier for the user to name, or rename, image files, the user may to a higher extent name the image files, instead of e.g. relying on an automatic file name generation. This implies that image files to a higher extent will have file names associated to the content of the image file, which, in turn, will make it easier to navigate among the image files.

The associating may be performed upon actuation of a key of said keypad.

An advantage of this is that the user of the apparatus has the opportunity to confirm, or not confirm, the text, before the text is associated to the image data. This key may be a soft key.

In a second aspect, the disclosed embodimentsare directed to an apparatus comprising a keypad, a display configured to show image data, a camera operating in a camera mode of said apparatus, a controller and a mode controller, wherein a data amending function is associated to a first key of said keypad in said camera mode.

An advantage of this is that the data amending function may be reached fast and easily by the user.

Another advantage is that the function of the keypad depends on the mode of the apparatus, which implies that the keypad may be utilised more efficient.

As mentioned above, such a data amending function may be an image manipulating function or a text associating function.

The apparatus may further comprise a cursor control mechanism configured to generate cursor control output data, and a cursor controller configured to transform said cursor control data to coordinate data and transmit said coordinate data to said data amending function.

An advantage of this is that coordinate data may be added to the data amending function. This implies, for example, that the location of the text added by the text adding function may be determined by the user.

The first key may be a character related key.

The apparatus according to the second aspect may further comprise an image sending function associated to a second key of said keypad in said camera mode.

Such an image sending function may be a function for sending image data to another apparatus using MMS, e-mail etc. Alternatively, such an image sending function may be a function configured to send image data to an external storing media, such as a hard drive or a server. Still an alternative is to automatically send the image data to a web server and to publish the image data on the Internet.

The second key may be a character related key.

The apparatus according to the second aspect may further comprise a meta information handling function associated to a third key of said keypad in said camera mode.

An advantage of this is that meta information associated to the image data may be added, or edited, easily by the user of the apparatus. By making it easier to add, or edit, meta information associated to the image data, more users will probably add, or edit, meta information associated to image data. An implication of this is that it will be easier to organize and search among image files.

Such a meta information handling function may be a file name handling function.

The third key of the apparatus may be a character related key.

The apparatus according to the second aspect may further comprise an image displaying function associated to a fourth key of said keypad in said camera mode.

An advantage of this is that the displaying of image data may fast and easily be changed according to the preferences of the user.

Such an image displaying function may be a zoom in function, a zoom out function or a full screen function.

The apparatus according to the second aspect of the invention may further comprise a cursor control mechanism configured to generate cursor control output data, and a cursor controller configured to transform said cursor control data to coordinate data and transmit said coordinate data to said image displaying function.

An advantage of transmitting coordinate data to the image displaying function is, for example, that it is possible to determine which part of the image data that is to be zoomed in.

The fourth key may be a character related key.

In a third aspect, the disclosed embodimentsare directed to a computer-readable medium having computer-executable components comprising instructions for entering a camera mode, switching keypad configuration to a camera mode keypad configuration, receiving image data, executing a data amending function upon an actuation of a first key of said keypad, and amending said data using said data amending function.

The computer-readable medium according to the third aspect may further comprise instructions for receiving cursor control output data, transforming said cursor control output data to coordinate data, and transmitting said coordinate data to said data amending function.

As mentioned above, such a data amending function may be an image manipulating function or a text associating function.

The first key may be a character related key of said keypad.

The computer-readable medium according to the third aspect may further comprise instructions for executing an image sending function upon an actuation of a second key of said keypad, and sending said image data using said image sending function.

The computer-readable medium according to the third aspect may further comprise instructions for executing a meta information handling function upon an actuation of a third key of said keypad, and handling meta information associated to said image data using said meta information handling function.

The computer-readable medium according to the third aspect may further comprise instructions for executing an image displaying function upon an actuation of a fourth key of said keypad, and displaying said image data using said image displaying function.

Features from the first and second aspect of the invention may also be applicable in this third aspect, as well as the features of the first aspect may be applicable in the second aspect.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional features and advantages of the disclosed embodiments, will be better understood through the following illustrative and non-limiting detailed description of preferred embodiments, with reference to the appended drawings, where the same reference numerals will be used for similar elements, wherein:

FIG. 1 is a flowchart illustrating an embodiment of a method according to the disclosed embodiments.

FIG. 2 is a flowchart illustrating another embodiment of a method according to the disclosed embodiments.

FIG. 3 is a flowchart illustrating yet another embodiment of a method according to the disclosed embodiments.

FIG. 4 is a flowchart illustrating still another embodiment of a method according to the disclosed embodiments.

FIG. 5 schematically illustrates an example of an image manipulating function.

FIG. 6 schematically illustrates another example of an image manipulating function.

FIG. 7 schematically illustrates still another example of an image manipulating function.

FIGS. 8a and 8b illustrate an example of an image sending function.

FIG. 9 schematically illustrates an apparatus according to the disclosed embodiments.

FIG. 10 is a flowchart illustrating a general embodiment of a method according to the disclosed embodiments.

### DETAILED DESCRIPTION OF PREFERRED EMBODIMENTS

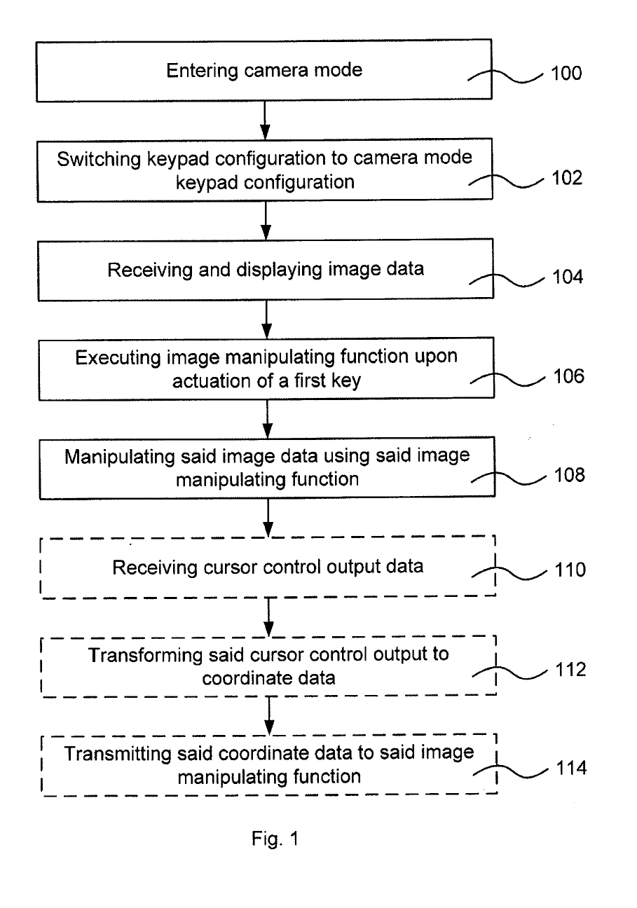

FIG. 1 is a flow chart illustrating an embodiment of a method according to the disclosed embodiments describing the image manipulating process of received image data.

In a first step, 100, a camera mode is entered by an apparatus, such as a mobile communication terminal. The mode of the apparatus may, for instance, be switched from communication mode to camera mode by a key input actuation, or by removing a lens cap of a camera comprised in the apparatus.

Thereafter, in a second step, 102, a keypad configuration of the apparatus is switched to a camera mode keypad configuration. For instance, the keypad configuration may be switched from a communication mode keypad configuration, i.e. a keypad configuration utilised when e.g. dialing a number, to the camera mode keypad configuration, i.e. a keypad configuration where camera specific functions are associated to the keys of the keypad.

Next, in a third step, 104, image data is received. The received image data may be present image data, temporarily stored image data, or stored image data.

The present image data is image data which is continuously updated by the camera comprised in the apparatus. Most often, the present image data is temporarily stored in a memory of the apparatus. Further, when the apparatus is in a camera mode, the present image data can be shown on a display of the apparatus.

If the user of the apparatus decides to store the present image data, he may, for instance, press a button on the apparatus. Then, the present image data is converted to temporarily stored image data. Before the temporarily stored image data is stored, the user may, for instance, decide in which folder the image data is to be stored. When the image data is stored by the user in a user-available memory, the image data is considered as stored image data.

Then, in a fourth step, 106, after having received image data, an image manipulating function is executed upon activation of a first key. Such an image manipulating function may be an image filter function, such as a BW (Black & White) image filter function, or in other words a greyscale image filter function, transforming color image data, such as RGB image data, to greyscale image data.

Next, in a sixth step, 108, the image data is manipulated using the image manipulating function.

For example, the first key may be a numerical “1”, button of the apparatus, and the image manipulating function may be a BW image filter function. By pressing the “1” button, the image data, which is assumed to be color image data, is transformed into BW image data. Optionally, the image data may be re-transformed into color image data by pressing the “1” button once again.

Optionally, in a seventh step, 110, cursor control data may be received. Then, in an eighth step, 112, the cursor control data may be transformed into coordinate data, and, in a ninth step, 114, the coordinate data may be transmitted to the image manipulating function.

Such coordinate data may be useful in certain image manipulating functions. For example, the image manipulating function may be a text adding function configured to be executed when a first key is actuated. In a first step of such a text adding function, a text box may be added. Then, in a second step, a text may be written in the text box. Thereafter, in a third step, the text box may be placed in accordance to the received coordinate data.

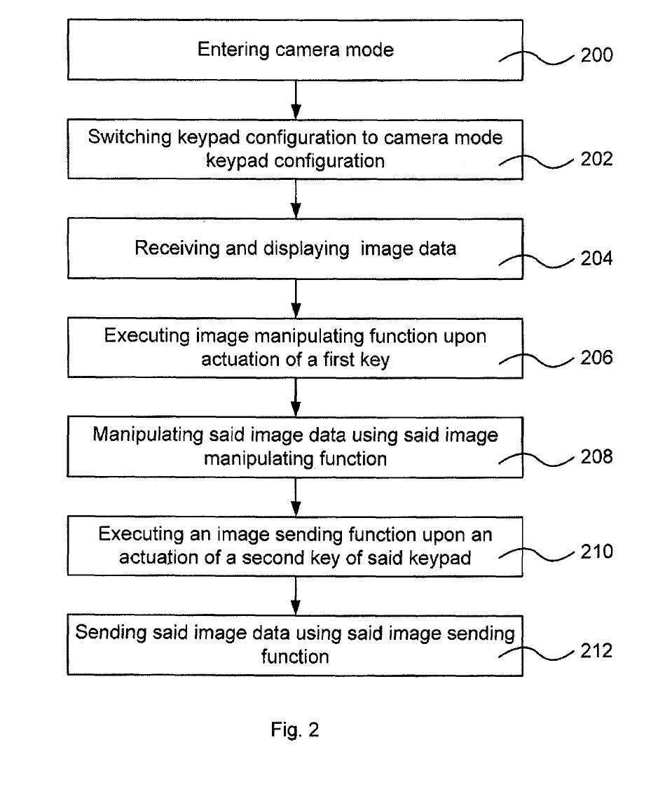

FIG. 2 is a flow chart illustrating a method of an embodiment of the disclosed embodiments describing the image manipulating process of the received image data and the image sending process of the received image data.

The first five steps of the flowchart, 200 to 208, corresponds to the first five steps of the flowchart illustrated in FIG. 1, 100 to 108.

In a sixth step, 210, an image sending function is executed upon an actuation of a second key of the keypad.

In a seventh step, 212, image data may be sent using said image sending function.

For example, the second key may be a numerical “2” button of the apparatus, and the image sending function may be an e-mail sending function. By pressing the “2” button, a new e-mail may automatically be generated and the image data may automatically be transformed into an image attached to the generated e-mail. After a receiving e-mail address and an optional text have been added the e-mail may be sent.

Optionally, when pressing the second key, the keypad configuration may be switched from camera mode keypad configuration to a text mode keypad configuration.

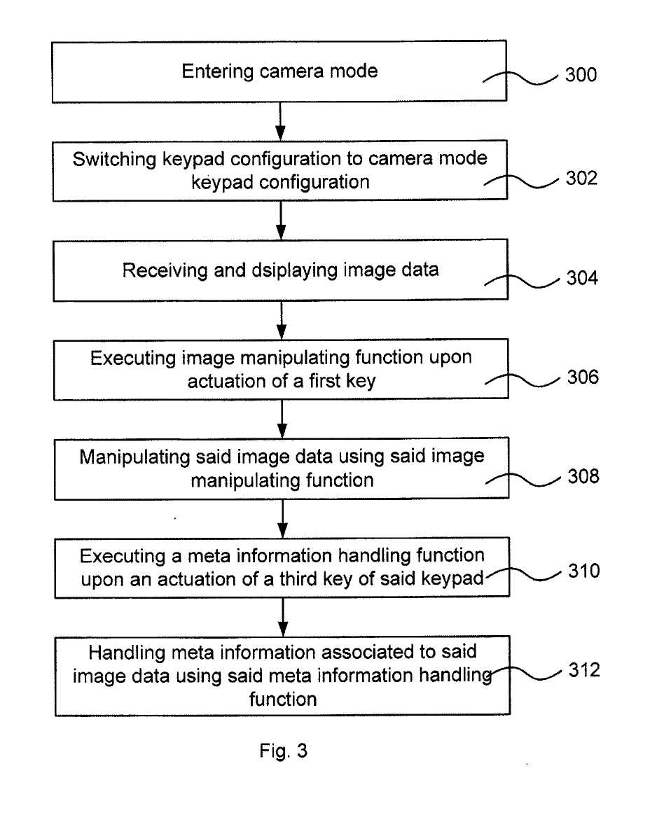

FIG. 3 is a flow chart illustrating a method of an embodiment of the disclosed embodiments describing the image manipulating process of the received image data and the meta information handling process of the received image data.

The first five steps of the flow chart, 300 to 308, corresponds to the first five steps of the flow chart illustrated in FIG. 1, 100 to 108.

In a sixth step, 310, a meta information handling function is executed upon an actuation of a third key of the keypad.

In a seventh step, 312, meta information associated to the image data may be handled using the meta information handling function.

For example, the third key may be a numerical “3” button of the apparatus, and the meta information handling function may be a file name handling function. By pressing the “3” button, a text box may appear on the display allowing the user to enter a name of the image file. If no image file exists, i.e. the image data is present image data or temporarily stored image data, the file name may be temporarily stored and added to the next stored image file.

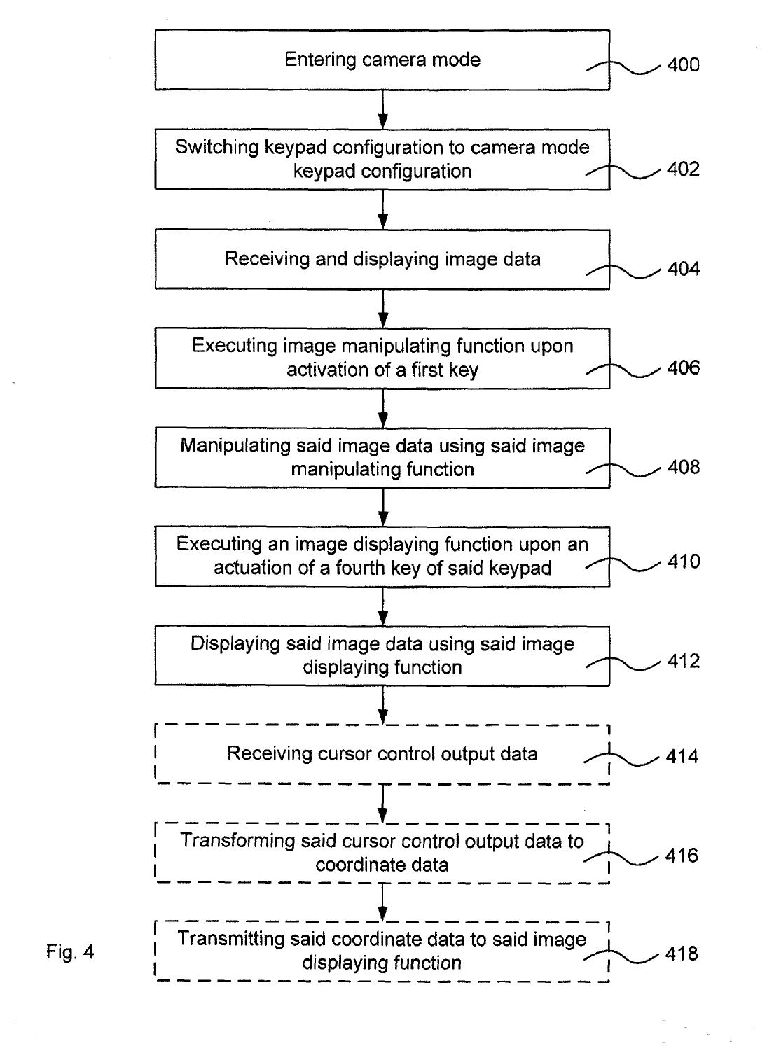

FIG. 4 is a flow chart illustrating an embodiment of a method according to the disclosed embodiments describing the image manipulating process and the image displaying process.

The first five steps of the flow chart, 400 to 408, corresponds to the first five steps of the flow chart illustrated in FIG. 1, 100 to 108.

In a sixth step, 410, an image displaying function is executed upon an actuation of a fourth key of the keypad.

In a seventh step, 412, the image data may be displayed using the image displaying function.

For example, the fourth key may be a numerical “4” button of the apparatus, and the image displaying function may be a full screen function. Hence, by pressing the “4” button, the image data may be shown on the entire display. Optionally, by pressing the “4” button once again, the full screen mode is left and the prior mode is entered.

Optionally, in an eighth step, 414, cursor control data may be received. Then, in a ninth step, 416, the cursor control data may be transformed into coordinate data, and, in a tenth step, 418, the coordinate data may be transmitted to the image displaying function.

Such coordinate data may useful in image displaying functions. For example, the image displaying function may be a zoom in function configured to be executed when a fourth key is actuated. In a first step of such a zoom in function, a cursor is located in accordance to received coordinate data. Then, in a second step, the area around the cursor is zoomed in.

The amount of zoom may be determined by the number of times the button has been pressed down, or, alternatively, when the zoom in function is entered the keypad configuration may be set to a zoom in keypad configuration, in which, for example, the button “1” corresponds to 100% zoom (i.e. no zoom), the button “2” corresponds to 200% zoom, the “3” corresponds to 300% zoom etc.

Alternatively, the cursor may be used to select a sub-area of the image. In a next step, the sub-area of the image may be shown on the display. The result of such a zoom in function may be the same as the result of an image cropping function illustrated in FIG. 6.

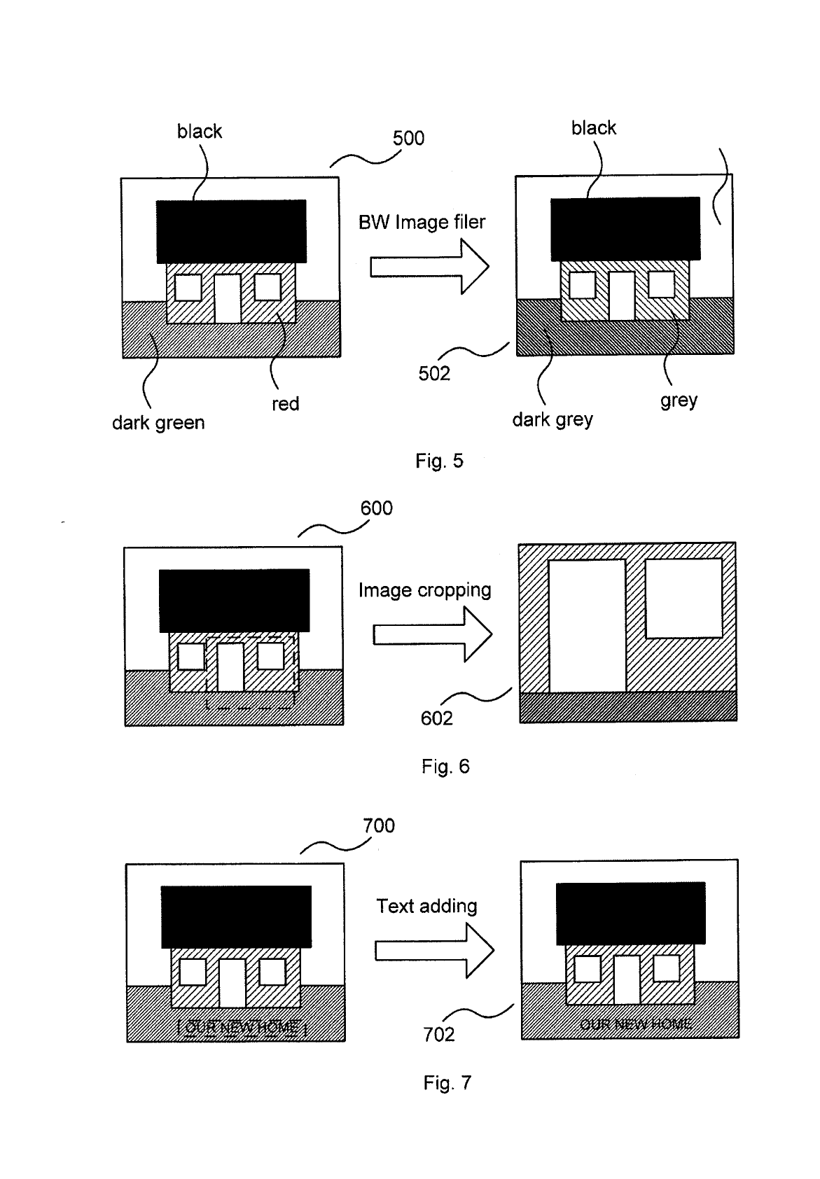

FIG. 5 schematically illustrates an example of an image manipulating function, more particularly a BW image filter function.

First, original color image data 500 is present on the display of the apparatus. Then, after the first key of the keypad has been actuated, a BW image filter function is executed and the image data is transformed to BW image data 502.

Optionally, if the user changes his mind, the first key may be actuated once again, and the BW image data 502 may be re-transformed into the original color image data 500. Since the color image data contains more information than the BW image data, the color image data has to be stored in order to enable this re-transformation.

FIG. 6 schematically illustrates another example of an image manipulating function, more particularly an image cropping function.

First, a sub-area of the original image data 600 may be marked with the help of a cursor. Then, using the image cropping function, image data within the marked sub-area may be set to be new image data 602.

FIG. 7 schematically illustrates another example of an image manipulating function, more particularly a text adding function.

First, a text box is added to original image data, and, next, a text is added to the text box. By using a cursor, the location of the text box may be determined. When having determined the text and the location of the text box, the text and optionally the text box may be included in the image data.

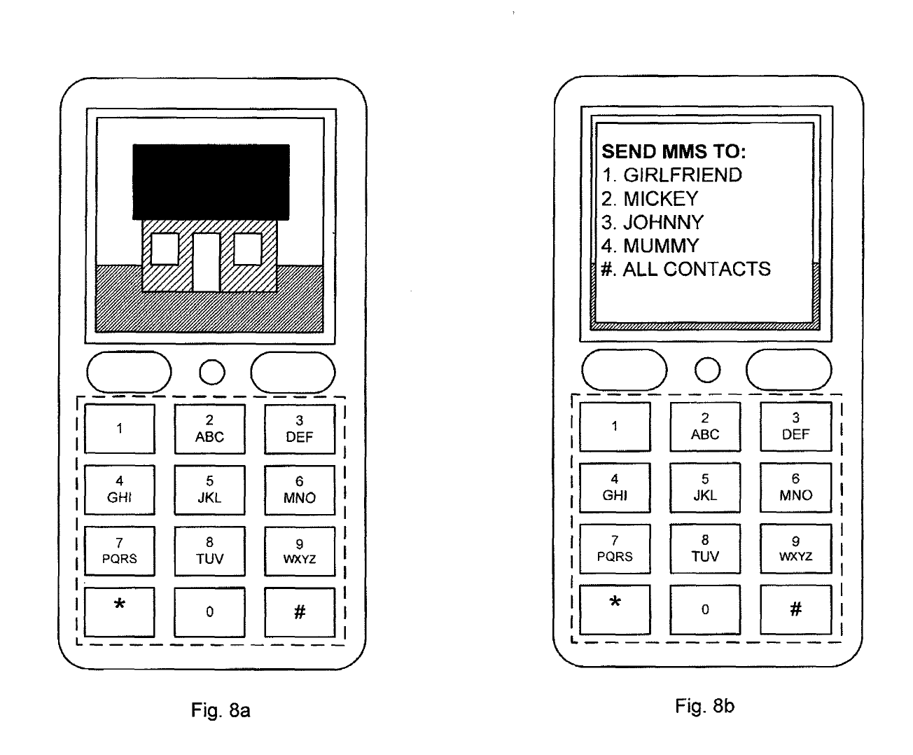

FIGS. 8a and 8b illustrate an example of an image sending function, more particularly an MMS sending function.

First, as illustrated FIG. 8a, image data is received by an apparatus. By pressing a second key, e.g. the “2”, key, of a keypad, which is configured in camera mode keypad configuration, of the apparatus, an image sending function, such as an MMS sending function, is executed.

Second, as illustrated in FIG. 8b, a number of contacts may be shown on the display of the apparatus. Each of the contacts may be associated to a key, as is indicated in FIG. 8b. If, e.g. the key “2” is pressed, an MMS comprising the image data shown in FIG. 8a, is sent to the contact denoted “Mickey”. Further, there may keys associated to more than one recipients. For example, if the “#” button of FIG. 8b is pressed the image data is sent to all contacts.

Alternatively, the contacts may be presented in a contact list, which may be controlled using a cursor control device.

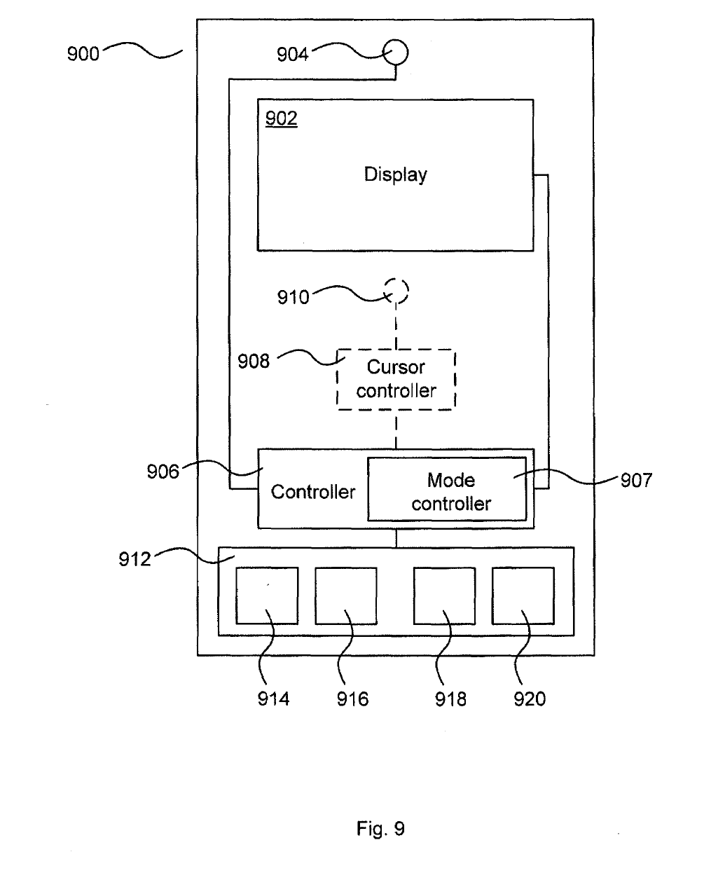

FIG. 9 schematically illustrates an apparatus 900 according to the disclosed embodiments.

The apparatus 900 comprises a display 902, a camera 904, a controller 906, a mode controller 907, optionally a cursor controller 908, optionally a cursor control mechanism 910, a keypad 912 comprising a first key 914, a second key 916, a third key 918 and a fourth key 920.

The display 902 may be an LCD configured to present a graphical user interface, as well as image data generated by the camera 904, to the user of the apparatus 900.

Generally, the controller 906 is configured to control the operation of the apparatus 900. More particularly, the apparatus is configured to receive image data from the camera 904, coordinate data from the cursor controller 908, key input actuation data from the keypad 912 and to transmit graphics data to the display 902. The controller 906 may comprise a processor and a memory.

The mode controller 907 may be configured to switch mode of the apparatus, e.g. switching to camera mode when the lens cap of the camera is removed. The mode controller 907 may be a software module comprised within the controller 906.

The cursor controller 908 is configured to receive cursor control output data from the cursor control mechanism 910, to transform this received cursor control output data to coordinate data, and to output the coordinate data to the controller 906.

The cursor controller 908 may be software implemented or hardware implemented, or a combination thereof, such as an FPGA circuit.

Further, the cursor controller 908 may be comprised within the controller 906.

The keypad 912 may comprise of a first number of soft keys and a second number of character related keys. The keypad may be configured according to the ITU-T standard.

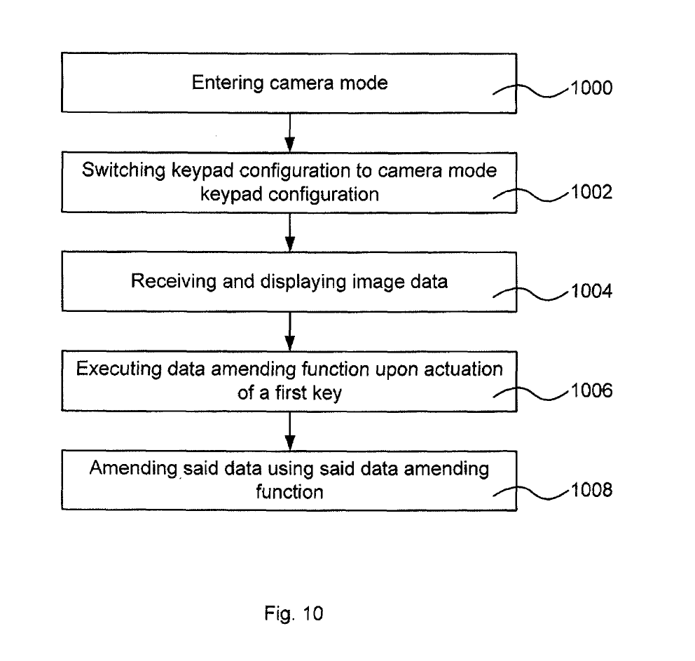

FIG. 10 is a flow chart illustrating a general embodiment of a method according to the disclosed embodiments.

In a first step, 1000, a camera mode is entered by an apparatus, such as a mobile communication terminal. The mode of the apparatus may, for instance, be switched from communication mode to camera mode by a key input actuation, or by removing a lens cap of a camera comprised in the apparatus.

Thereafter, in a second step, 1002, a keypad configuration of the apparatus is switched to a camera mode keypad configuration. For instance, the keypad configuration may be switched from a communication mode keypad configuration, i.e. a keypad configuration utilised when e.g. dialing a number, to the camera mode keypad configuration, i.e. a keypad configuration where camera specific functions are associated to the keys of the keypad.

Next, in a third step, 1004, image data is received. The received image data may be present image data, temporarily stored image data, or stored image data.

The present image data is image data which is continuously updated by the camera comprised in the apparatus. Most often, the present image data is temporarily stored in a memory of the apparatus. Further, when the apparatus is in a camera mode, the present image data can be shown on a display of the apparatus.

Then, in a fourth step, 1006, after having received image data, an data amending function is executed upon activation of a first key.

Next, in a sixth step, 1008, the data is amended using the data amending function.

The invention has mainly been described above with reference to a few embodiments. However, as is readily appreciated by a person skilled in the art, other embodiments than the ones disclosed above are equally possible within the scope of the invention, as defined by the appended patent claims.

We hereby claim:

1. A method for amending data for an apparatus in a camera mode, said apparatus comprising a keypad, a display and a camera, said method comprising
entering a camera mode,
switching keypad configuration to a camera mode keypad configuration,
receiving image data,
showing said image data on said display,
executing a data amending function upon an actuation of a first key of said keypad, and
amending said data using said data amending function.

2. The method according to claim 1, wherein said data amending function is an image manipulating function configured to manipulate image data captured by said apparatus.

3. The method according to claim 2, wherein said image manipulating function comprises an image filter function.

4. The method according to claim 2, wherein said image manipulating function comprises an image cropping function.

5. The method according to claim 2, wherein said image manipulating function comprises a text adding function.

6. The method according to claim 2, wherein said apparatus further comprises a cursor control mechanism, said method further comprising
receiving cursor control output data,
transforming said cursor control output data to coordinate data, and
transmitting said coordinate data to said image manipulating function.

7. The method according to claim 2, wherein said first key is a character related key of said keypad.

8. The method according to claim 2, further comprising
executing an image sending function upon an actuation of a second key of said keypad, and
sending said image data using said image sending function.

9. The method according to claim 8, wherein said second key is a character related key of said keypad.

10. The method according to claim 2, further comprising
executing a meta information handling function upon an actuation of a third key of said keypad, and
handling meta information associated to said image data using said meta information handling function.

11. The method according to claim 10, wherein said meta information handling function comprises a file name handling function.

12. The method according to claim 10, wherein said third key is a character related key.

13. The method according to claim 2, further comprising
executing an image displaying function upon an actuation of a fourth key of said keypad, and
displaying said image data using said image displaying function.

14. The method according to claim 13, wherein said image displaying function comprises a zoom in function.

15. The method according to claim 13, wherein said image displaying function comprises a zoom out function.

16. The method according to claim 13, wherein said image displaying function comprises a full screen function.

17. The method according to claim 13, wherein said apparatus further comprises a cursor control mechanism, further comprising
receiving cursor control output data,
transforming said cursor control output data to coordinate data, and
transmitting said coordinate data to said image displaying function.

18. The method according to claim 13, wherein said fourth key is a character related key.

19. The method according to claim 1, wherein said data amending function is a text associating function configured to associate a text to said image data, wherein said amending comprises
receiving a text upon actuation of at least one character related key of said keypad, and
associating said text to said image data.

20. The method according to claim 19, further comprising
receiving cursor control output data from a cursor control mechanism,
transforming said cursor control output data to coordinate data, and
locating said associated text in a position in said image data corresponding to said coordinate data.

21. The method according to claim 19, further comprising
storing said image data as an image file,
naming said image file in accordance to said associated text.

22. An apparatus comprising
a keypad,
a display configured to show image data,
a camera operating in a camera mode of said apparatus,
a controller, and
a mode controller,
wherein a data amending function is associated to a first key of said keypad in said camera mode.

23. The apparatus according to claim 22, further comprising
a cursor control mechanism configured to generate cursor control output data, and
a cursor controller configured to transform said cursor control data to coordinate data and transmit said coordinate data to said data amending function.

24. The apparatus according to claim 22, wherein said first key is a character related key.

25. The apparatus according to claim 22, wherein an image sending function is associated to a second key of said keypad in said camera mode.

26. The apparatus according to claim 25, wherein said second key is a character related key.

27. The apparatus according to claim 22, wherein a meta information handling function is associated to a third key of said keypad in said camera mode.

28. The apparatus according to claim 25, wherein said third key is a character related key.

29. The apparatus according to claim 22, wherein an image displaying function is associated to a fourth key of said keypad in said camera mode.

30. The apparatus according to claim 29, further comprising
a cursor control mechanism configured to generate cursor control output data, and
a cursor controller configured to transform said cursor control data to coordinate data and transmit said coordinate data to said image displaying function.

31. The apparatus according to claim 28, wherein said fourth key is a character related key.

32. A computer-readable medium having computer-executable components comprising instructions for
entering a camera mode,
switching keypad configuration to a camera mode keypad configuration,
receiving image data,
executing a data amending function upon an actuation of a first key of said keypad, and
amending said data using said data amending function.

33. The computer-readable medium according to claim 32, further comprising instructions for
receiving cursor control output data,
transforming said cursor control output data to coordinate data, and
transmitting said coordinate data to said data amending function.

34. The computer-readable medium according to claim 32, wherein said first key is a character related key of said keypad.

35. The computer-readable medium according to claim 32, further comprising
executing an image sending function upon an actuation of a second key of said keypad, and
sending said image data using said image sending function.

36. The computer-readable medium according to claim 32, further comprising
executing a meta information handling function upon an actuation of a third key of said keypad, and
handling meta information associated to said image data using said meta information handling function.

37. The computer-readable medium according to claim 32, further comprising
executing an image displaying function upon an actuation of a fourth key of said keypad, and
displaying said image data using said image displaying function.
